(19) United States
(12) Patent Application Publication
(10) Pub. No.: US 2006/0013931 A1
(43) Pub. Date: Jan. 19, 2006

(54) Filter and method for cooking oil filtration

(76) Inventors: Thomas Bivens, Magnolia, TX (US); J. G. Clark, Signal Mountain, TN (US)

Correspondence Address: KEELING HUDSON LLC, P.O. BOX 70103, HOUSTON, TX, 77270, US

(21) Appl. No.: 11/179,933

(22) Filed: Jul. 12, 2005

Related U.S. Application Data
(60) Provisional application No. 60/587,347, filed on Jul. 13, 2004.

(51) Int. Cl. A23C 15/14

(52) U.S. Cl. 426/417

(57) ABSTRACT

The present invention comprises a cooking oil filter comprising a synthetic non-woven felt material and a method of filtering cooking oil utilizing a non-woven synthetic material applied at operational cooking oil temperatures.

### CROSS-REFERENCE TO RELATED APPLICATIONS

This application claims the benefit of U.S. Provisional Patent Application No. 60/587,347 entitled, “Felt Filter for Cooking Oil,” filed on Jul. 13, 2004, in the United States Patent and Trademark Office.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to filters used in deep-fat frying, and more particularly to a polyester filter for use with deep-fat fryer filters.

2. Description of the Related Art

Cooking oil is extensively used in the food industry to cook various comestibles. Animal fat or other suitable material may sometimes be used as the cooking material in lieu of cooking oil. The term “cooking oil” is used herein to designate vegetable oil, canola oil, saffron oil, sunflower oil, animal fat or other suitable material known in the art.

Frying is frequently accomplished in relatively deep containers with the comestible to be cooked immersed in the cooking oil. The frying operation is generally conducted at temperatures between 157° C. and 204° C. (315° F. and 400° F.). While higher temperatures provide decreased cooking times and reduced oil adsorption in the comestible, higher temperatures also accelerate degradation of the cooking oil.

In regular operation, the cooking oil becomes contaminated with food particulates and impurities such as free fatty acids, polymers, alkalines and other polar compounds. These contaminants can cause discoloration of the cooking oil, a change in alkalinity or acidity, and a reduction in thermal efficiency and smoking due to degradation. If the contamination is too high, the cooking oil will have to be discarded. To help extend the useful life of the cooking oil, filtration is commonly employed to control or reduce contaminants.

In a restaurant operation, the cooking oil is typically filtered once or twice daily. Common cooking oil filters used in restaurants include a filter support, supporting filter paper or a filter pad, with a pump to draw the cooking oil through the filter paper. Other common filter materials taught in the art include paper filters and metal filter screens.

Paper filters are inexpensive. However, paper filters are not capable of re-use, are fragile and provide limited separation efficiency.

Filter pads may be constructed of a bonded fibrous material such as cellulose fibers bound by a resin. Filter pads retain cooking oil, are not adaptable to forming filter envelopes that wrap around a spacing grid and are not re-usable.

Recent improvements to the art include stainless steel filter screens operable without filter paper, which provides a re-usable filter. Metal filter screens, while durable, involve initial costs higher than paper filters and filter pads and provided limited separation efficiency.

Filter paper, filter pads and steel filters provide passive filtration in that they provide a filtering surface with openings. The openings are liquid-permeable, allowing the cooking oil to pass through while filtering particles from the oil.

To increase filtration efficiency, a filter aid is commonly used in concert with the filter. Such filter aids may comprise a powder to form a powder cake to enhance removal of relatively small particles. Filter aids often include adsorbents or neutralizing agents to provide active filtration, that is chemical treatment or electrostatic bonding of contaminants on a molecular level. In some instances, filter aids may be impregnated in filter paper or filter pads. Examples of filter aids include silicates, particularly calcium silicate and magnesium silicate, to remove free fatty acids, and diatomaceous earth or pearlite to provide more surface area to retain particulates.

If filter powder is used, the filter powder is commonly disbursed in the cooking oil to allow accumulation of the filter powder on the outer surface of the filter media. Such filter powder, when accumulated, provides a plurality of channels permeable to liquid, yet more effective in mechanically filtering particles, specifically small particulates. Such filter powder thus provides depth filtration as compared to the surface filtration of paper, stainless steel and some filter pads. While such depth filtration is desirable for reducing through flow of fine particles, a portion of the filter powder becomes a contaminant of the filter oil. Smaller powder particles pass through the filter and contaminate the cooking oil and adhere to comestibles during the frying process. It would be an advantage to the prior art to provide a filter medium that provides depth filtration without the assistance of filter powder, thereby preventing or reducing the need for filter cake.

Additionally, activated carbon may be employed to decolorize the cooking oil and reduce odor-causing components, and alkalis may be added to neutralize the cooking oil.

While synthetic felt materials have been historically practiced for solid-fluid separation in wet and dry applications, use of such materials for filtering cooking oils has not been practiced. Conventionally, polyester, polypropylene, and nylon have not been considered appropriate for filtering cooking oil because of the temperature of the cooking oil and the softening or melt temperature of such synthetic materials. Published melt temperatures include 250-260° C. (480-500° F.) for polyester, 170° C. (338° F.) for polypropylene, 220° C. (428° F.) for nylon Type 6, and 265° C. (509° F.) for nylon Type 6,6 (Mark's Standard Handbook for Mechanical Engineers, 10^{th} Edition).

While synthetic felt filters have been used in various dry and wet filtration applications, synthetic felt filters have not been commercially practiced for filtering hot cooking oil. Manufacturers of polyester felt filter media indicate an upper limit of application temperature of 163° C. (325° F.). By way of example, Sutherland Felt Company, a manufacturer of synthetic and other felts, recommends an application temperature of up to 149° C. (300° F.) and American Felt & Filter Company recommends a continuous operating temperature in dry applications of 132° C. (270° F.). Accordingly, the prior art teaches away from using polyester felt in hot cooking oil applications.

A survey of published information of manufacturers or distributors of non-woven material, including Lantor Advanced Materials Group, National Nonwovens, Western Nonwovens, Inc., Southern Felt Company, Inc., Knowlton Specialty Papers, Inc., American Industrial Felt & Supply, and Sutherland Felt all fail to disclose any known application of polyester felt material applications for use in high temperature environments typically seen in flying operations

In batch filtration operations, restaurants stop flying operations and filter the cooking oil. Accordingly, the cooking oil will be at or near cooking temperature. In a restaurant environment, the batch filtration continues until subjective determination is made that the filtering process has achieved a desired result. Once filtration ceases, cooking oil is returned to the fryer.

The general practice is to pass the cooking oil through a filter media, which is either impregnated with filter cake or encompassed by a layer of filter cake external the filter media. A separate filtration container is typically used. Cooking oil is drained from the fryer to the filtration container. The cooking oil is then cycled through the filter media. The extent of contaminants removed during the filtering process depends on the filter media and the type and extent of filter powder used. Typically, cooking oil is discarded every five to ten (5-10) days due to accumulated contamination and degradation of the cooking oil.

It would be an improvement to the art to provide filter media for filtering cooking oil that is re-usable. It would be a further improvement to the art to provide filter media that allow depth filtration, thereby reducing the need for filter powder.

### BRIEF SUMMARY OF THE INVENTION

The present invention comprises a cooking oil filter comprising a synthetic non-woven felt material and a method of filtering cooking oil utilizing a non-woven synthetic material applied at operational cooking oil temperatures.

### BRIEF DESCRIPTION OF THE DRAWINGS

FIG. 1 is a typical filter envelope comprised of a polyester filtering media of the present invention.

FIG. 2 is a cross-sectional side view of a fryer and filtration system, wherein the cooking oil is engaged in the filtration process.

FIG. 3 is a cross-sectional side-view of particulates caught within the non-woven filter media during the filtration process.

FIG. 4 depicts a cross-sectional view of a filter having a single panel of filter media.

### DESCRIPTION OF THE INVENTION

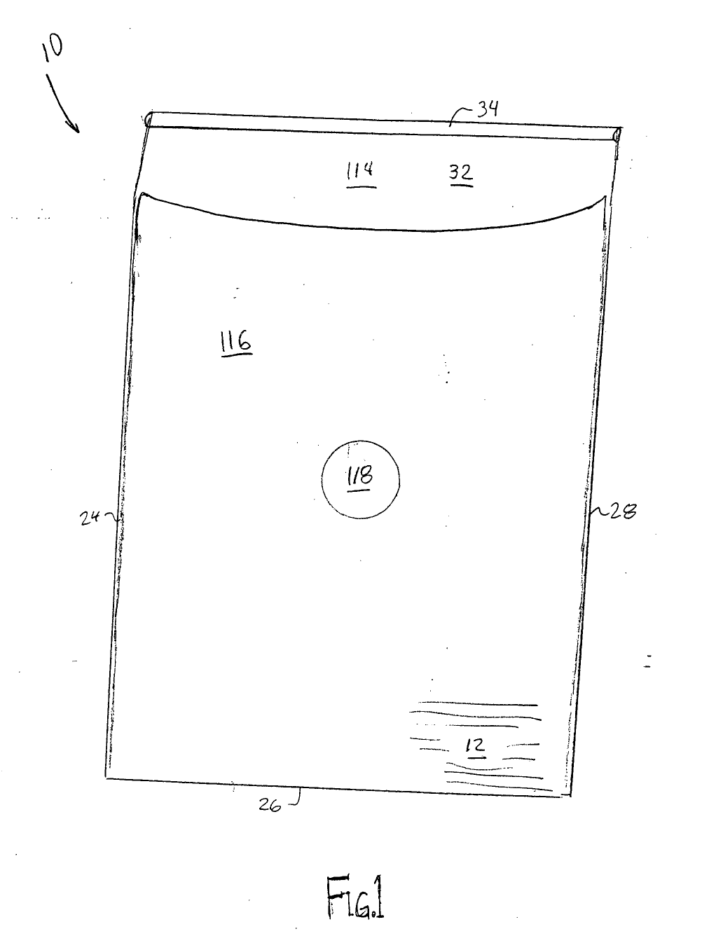

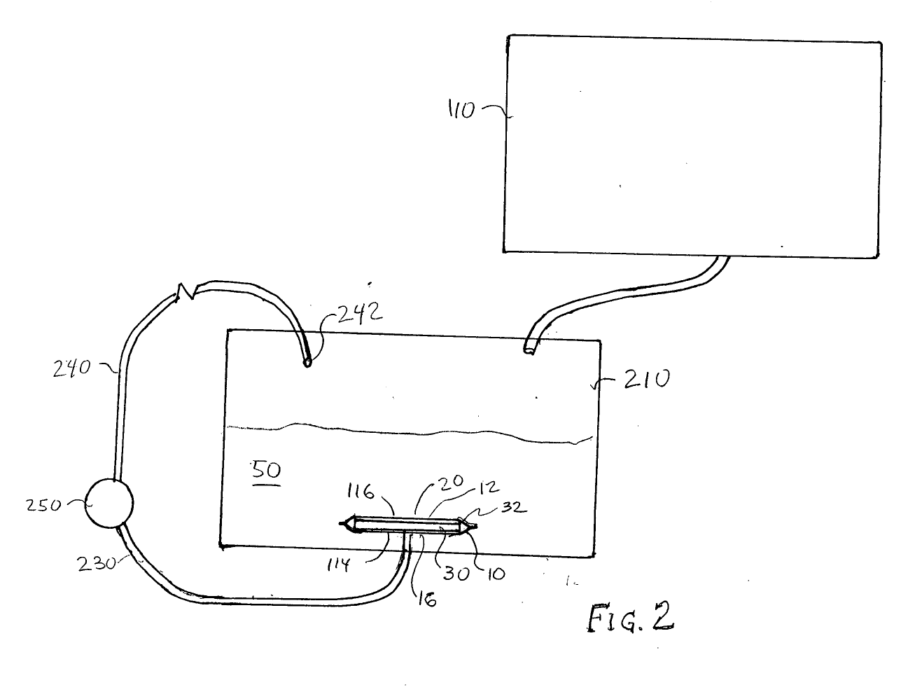

Referring to FIG. 1 and FIG. 2, there is shown at 10 an exemplary filter envelope for use with a filtering apparatus for a fryer of the type commonly used in cooking operations. The filter envelope 10 includes a first panel 116 and a second panel 114 (partially shown in FIG. 1). First panel 116 comprises a planar segment of felt filter media. Second panel 114 comprises a second planar segment of felt filter media. First panel 116 and second panel 114 are attached along filter media edges 24, 26 and 28 comprising the periphery of three sides of first panel 116 and second panel 114 to form a pocket for receiving spacer grid 30.

In the exemplary embodiment, second panel 114 is includes a flap 32 that extends beyond the fourth side 34 of panel 116. Flap 32 is sized such that the flap 32 may be folded over panel 116 after insertion of spacer grid 30 in the pocket created formed by panels 116 and 114. A clip 34 retains flap 32 in the folded position. An opening 118 is provided in one or both panels 114 and 116 to allow attachment to the vacuum line 230 by means of attachment structures, not depicted, known in the art.

In the preferred embodiment of the invention, filter media 10 is comprised of a synthetic felt material hereinafter described. Synthetic felt material as used herein comprises a manufactured sheet, web, or batt of synthetic non-woven material comprised of directionally or randomly oriented fibers.

Referring to FIG. 2, the cooking oil 50 is initially contained in a fryer 110 during cooking operation. Drain line 220 allows transfer of cooking oil 50 to a separate container 210 for filtration cycles.

Vacuum line 230, pump 250, and return line 240 allow cooking oil 50 to be drawn through filter 20 and returned to container 210. Typically, return line 240 comprises a flexible material allowing the outlet end 242 of line 240 to be moved between container 210 and fryer 110. Filter 20 comprises a spacer 30, a filter envelope 10 and associated tubing and hardware to allow cooking oil 50 to be drawn through filter envelope 10 and spacer 30 to vacuum line 230.

In operation, cooking oil 50 is drained through drain line 220 into container 210. Cooking oil 50 may be transferred while at temperatures in the range of 157° C. (315° F.) to 204° C. (400° F.), which range comprises the common range of frying temperatures in the restaurant industry. Vacuum pump 250 is then activated to draw cooking oil through vacuum line 230, thereby drawing cooking oil 50 through filter envelope 10 and spacer 30. The cooking oil is transmitted through return line 240 to container 210. The cooking oil 50 may thus be re-circulated for multiple filtration cycles.

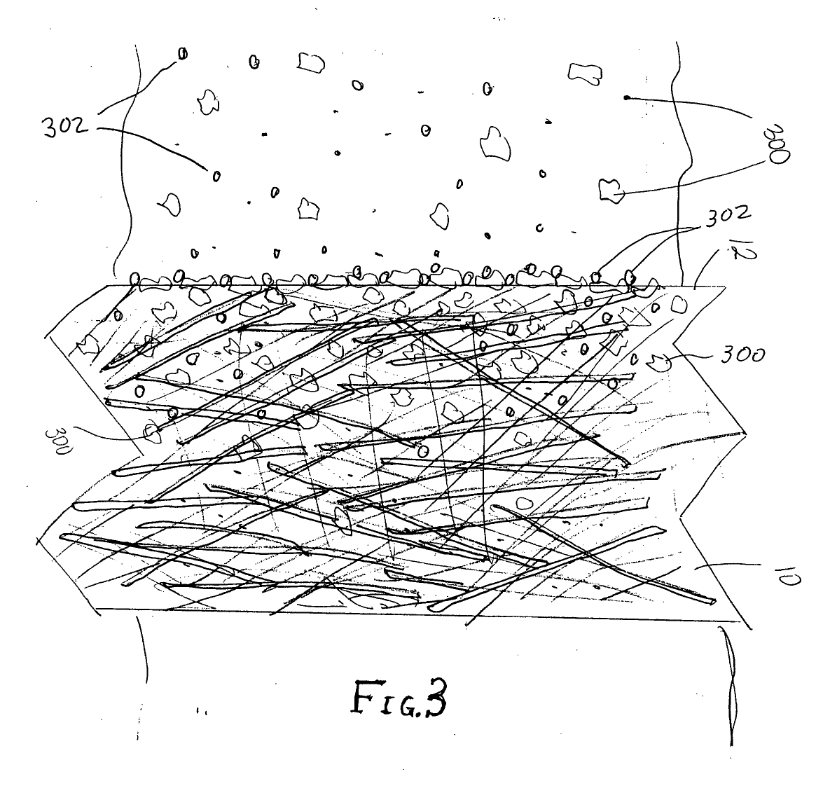

Referring to FIG. 3, a detail of panel 116 is depicted. As cooking oil 50 passes through panel 116 of filter envelope 10, contaminants 300 become lodged at the filter surface 12 or intermediate felt fibers 14 of panel 116. As filtration continues an accumulation of contaminates occurs on the filter surface 12. As cooking oil 50 passes through panel 114 (not shown in FIG. 3), contaminants 300 become lodged at filter surface 16 or intermediate felt fibers of panel 116 in like manner.

In operations where filter powder is used, the filter powder particles 302 are dispersed in the cooking oil 50. The filter powder particles 302 accumulate with contaminants 300 on the filter surface 12 or surface 16 or intermediate fibers 14. When sufficient accumulation of contaminants 300 and particles 302 occurs, the resulting filter cake enhances filtering of contaminants 300, particularly smaller contaminants 300.

Upon completion of re-circulation cycles of cooking oil 50 through filter 20, the outlet end 242 of line 240 may be inserted in fryer 110 to allow the cooking oil 50 to be returned to fryer 110.

Once cooking oil 50 has been returned to fryer 110, filter envelope 10 may be cleaned by scraping or may be dissembled from vacuum line 230 for extensive cleaning.

As the synthetic felt material of the present invention presents a surface 12 that is not readily torn or separated, scraping of the surface of filter envelope 10 results removal of the collected contaminants 300 on the surface of the filter envelope 10 without impairing the integrity of the filter media. The filter envelope 10 may additionally be sprayed to further remove particles 300 and powder 302.

In a preferred embodiment of the present invention, surface 12 of panel 116 and surface 16 of panel 114 are each treated by heat and pressure in a calendaring process to create a glazed surface 12 and a glazed surface 16. Such glazed surface comprises partially-melted fibers providing a relatively smooth surface. The glazed surface enhances removal of particles by scraping and washing. In an alternative embodiment, the surfaces 12 and 16 may be treated by a singing process of applying a flame to the surface to melt extending fibers. The singed surface is not as desirable as the glazed surface due to surface irregularities.

In the event that further cleaning of the filter envelope 10 of the present invention is required, filter envelope 10 is removed from the vacuum line 230, spacer 30 is removed from filter envelope 10 and filter envelope 10 is washed using conventional washing methods, such as placing the filter envelope 10 in a conventional dishwasher or washing machine or washing filter envelope 10 in a sink. Upon cleaning, spacer 30 is re-inserted in filter envelope 10 and the filter envelope 10 and spacer 30 may be re-attached to vacuum line 230. The filter 20 is thus prepared for re-use in a subsequent filtration cycle.

Such cleaning cycles may be continued until replacement of filter envelope 10 is determined necessary.

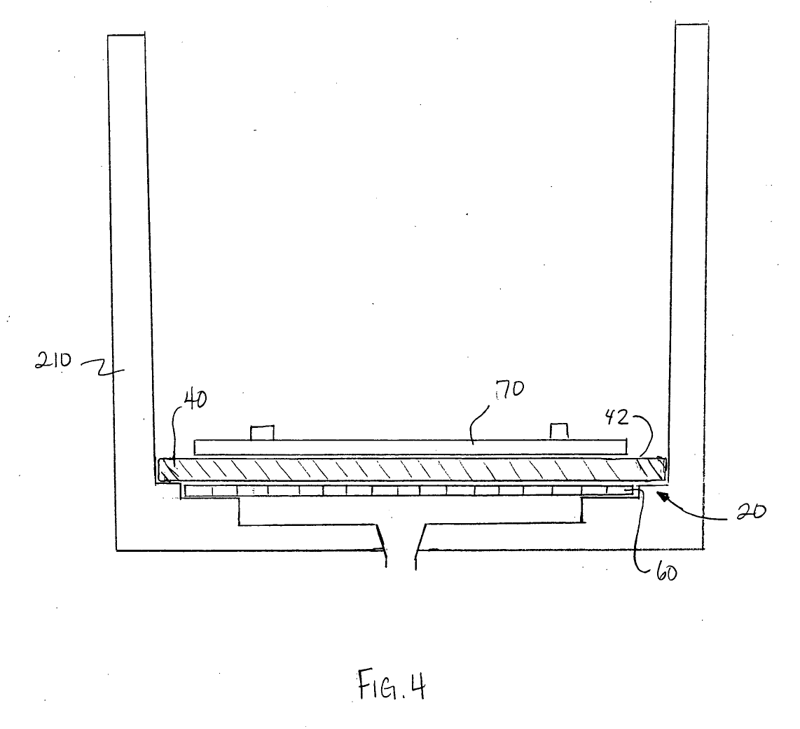

In an alternative embodiment as depicted in FIG. 4, the synthetic felt material of the present invention may be formed in a panel 40 for placement on a filter support 60. The principle of operation is the same. Instead of a filter envelope surrounding a spacer, single filter panel 40 is supported on support 60. A weighted hold-down plate 70 is positioned above filter panel 40, thereby securing filter 20 in place. The advantages of the synthetic felt material of the present invention remain. The single felt panel may be scraped for cleaning purposes or may be removed and cleaned by washing. Filter surface 42 is glazed in the preferred embodiment.

Polyester felt and nylon felt are each of sufficient strength and durability to allow for scraping of filtration surface 12 without damaging filter media 10.

In a series of tests, polyester felt was used as the filter media for filter 10 for batch filtration of contaminated cooking oil to determine whether a polyester felt filter 10 provided effective filtering of cooking oil in a commercial application environment, and whether filter media 10 could withstand the extreme temperatures seen in fryers.

### EXAMPLE 1

In a first test, polyester felt filters were used to filter a quantity of discarded cooking oil. The cooking oil was further used to fry a quantity of potatoes. Three filter envelopes were constructed, each filter envelope comprising a unique polyester filter. The unique polyester filters comprised:

Filter Media 1: A polyester felt filter having a porosity of 509.7 liters per minute (18 cubic feet per minute), a unit weight of 542.5 grams per square meter (16 ounces per square yard) and a thickness of 0.17 cm (0.065 inches).

Filter Media 2 (4) A polyester felt filter having a porosity of 141.6 liters per minute (5 cfm), and a unit weight of 440.8 grams per square meter (13 ounces per square yard) and a thickness of 0.09 cm (0.035 inches).

Filter Media 3 (5) A polyester felt filter having a porosity of 254.9 liters per minute (9 cfm), and a unit weight of 440.8 grams per square meter (13 ounces per square yard) and a thickness of 0.10 cm (0.040 inches).

Porosity was initially according to industry standard at 0.127 cm (½″) H₂O water column.

Each of the three filter envelopes were used to conduct three filtering operations analogous to a commercial batch filtering operation. The cooking oil was heated to 177° C. (350° F.) prior to each filtering operation. Flow rate of cooking oil through the cooking oil and quantity of cooking oil retained during filtering were determined. See Table 1. The flow rate did not decline for during the second and third filtering operation (in relation to the first filtering operation) for any of the filtering operations, indicating that there was no structural deterioration of the felt filters. The felt filters were then examined to determine any heat degradation. No evidence of physical degradation was observed.

The flow rate of each filter remained consistent during each of three filtration cycles for each of the filters.

Data from the test is set forth in Table 1.

TABLE 1

| | | | Filter | | |
|---|---|---|---|---|---|
| | | Flow-rate | Weight (g) | | Oil |
| Description | FFA | L/min (gpm) | Initial | Final | Retained (g) |
| Discard Oil | 2.33 | n/a | n/a | n/a | n/a |
| FM-1.1 | 2.18 | 6.06 (1.6) | — | — | — |
| FM-1.2 | 2.22 | 6.62 (1.75) | 139 | 213 | 74 |
| FM-1.3 (3-pass) | 2.26 | 6.32 (1.67) | 149 | 222 | 73 |
| FM-4.1 | 2.22 | 6.43 (1.7) | — | — | — |
| FM-4.2 | 2.26 | 6.28 (1.66) | 140 | 176 | 36 |
| FM-4.3 (3-pass) | 2.26 | 6.66 (1.76) | 126 | 171 | 45 |
| FM-5.1 | 2.23 | 6.06 (1.6) | — | — | — |
| FM-5.2 | 2.25 | 6.51 (1.72) | 141 | 188 | 47 |
| FM-5.3 (3-pass) | 2.28 | 6.36 (1.68) | 138 | 196 | 58 |

### EXAMPLE 2

A separate round of testing identified the performance of polyester felt media in batch filtration over an extended period of time. A first test was conducted at 177° C. (350° F.), which is a common flying temperature in the restaurant industry. A second test was conducted at 196° C. (385° F.). The flow rate of the cooking oil was measured to determine if the filter media remained effective after exposure to these temperatures. Table 2 provides a summary of the results:

TABLE 2

| | | Initial | | Ex- | | Result | Shrinkage |
|---|---|---|---|---|---|---|---|
| | Initial | Thick- | | posure | Result | Thick- | Length/ |
| Test | Flow | ness | Temp | Time | Flow | ness | Width |
| No. | (L/min) | (cm) | (° C.) | (min) | (L/min) | (cm) | (%) |
| 1 | 30.3 | 0.17 | 177 | 240 | 30.3 | 0.21 | 2%/3.5% |
| 2 | 30.3 | 0.16 | 196 | 240 | 32.2 | 0.22 | 4.5%/7% |

At 177° C., the flow rate remained constant after exposure for four (4) hours. The polyester felt filter experienced shrinkage across the length of 2% and across the width of 3.5%. The filter's thickness experienced an increase of 22%.

At 196° C., the flow rate increased slightly, approximately 6%, after exposure for four (4) hours. The polyester media experienced shrinkage across the length and the width of 4.5% and 7%, respectively. However, the polyester media experienced a 38% expansion across its thickness.

In a subsequent test, a quantity of felt media was simple soaked in cooking oil for a period of four (4) hours at ambient temperature of approximately 24° C. (75° F.). No measurable difference in length, width or thickness of the filter media was observed after such exposure. The subsequent test confirmed that the shrinkage in length and width and the increase in thickness resulted from the exposure temperature.

Effectively, the shrinkage across the length and width of the filter effectively reduced lateral interstice openings. However, the expansion across the thickness of the filter opened the vertical interstices (with the thickness direction considered vertical and length and width considered lateral). Further, the constant flow rate indicates that filtering capacity of the polyester filter is maintained, even under temperature conditions in excess of published recommendations of manufacturers of polyester felt filters. Upon visual inspection, no degradation of the felt was observed.

The increased thickness of the felt at such elevated temperature, properly specified, results in increased filter depth and provides further depth filtration benefits (as shown graphically in FIG. 3). Degradation of the polyester media was not detectable upon visual inspection.

### Field Test Applications

In a series of field test applications, polyester felt media was used in filtration units in multiple restaurants. For each field test, increased time between replacement of cooking oil was observed, with reported increase in cooking oil life ranging between 30% and 100%. It is noted that the variance results in part to different standards used by different users to determine conditions indicating a need to change cooking oil.

In such field test applications, the quantities of top-off oil required to maintain a determined level of cooking oil during testing was reported to be lower by an average of approximately 7%. Subjectively, such decrease is attributed to the resistance of polyester to absorption of liquids and to effectiveness of removal of oil-adsorbing particles.

A field test of nylon media indicates an equivalent or greater propensity to shrinkage at temperatures in the range of 177° C. (350° F.) to 196° C. (385° F.).

A preferred embodiment of the felt filter 20 of the present invention comprises utilization of a polyester felt filter media in a weight range of 1220.6 grams per square meter (6 ounces per square yard) to 4068.8 grams per square meter (20 ounces per square yard). In such preferred embodiment, each panel 116 or panel 114 of a filter envelope 10 is constructed of a length and width determined as follows: The length necessary to effectively encompass the spacer, including any necessary increase to allow for closing of the panel and connection to a corresponding panel is determined. This length is the Calculated Length. The width necessary to effectively encompass the spacer, including any necessary increase to allow for closing of the panel and connection to a corresponding panel is determined. This width is the Calculated Width. The filter envelope 10 is constructed from panels having a Panel Length and a Panel Width. The Panel Length is the Calculated Length plus a Length Shrinkage Allowance. The Panel Width is the Calculated Width plus a Width Shrinkage Allowance. In a preferred embodiment, the Length Shrinkage Allowance is in the range of 2% to 10%. In a preferred embodiment, the Width Shrinkage Allowance is in the range of 2% to 10%.

In an application involving a single filter media panel, the same factors for determining the Panel Length and the Panel Width is applied.

As a filter panel may be of any desired geometric structure, the foregoing principle may be more broadly applied by recognizing that a commercially-practiced filter includes at least one filter panel, the filter panel having a lateral surface defining a filter area, each said filter panel having a peripheral margin for either extending beyond a filter support in an envelope-style filter or simply to provide an overlap in a single filter panel structure to prevent flow-by of unfiltered cooking oil. To practice the present invention utilizing polyester or nylon felt, it is necessary to initially construct the filter panel with a shrinkage margin of 2% to 10% of the filter panel lateral dimension. Accordingly, it is necessary to determine the operational filter panel size parameters by determining the filter area and the operational peripheral margin of the filter panel and to construct the initial filter panel with a larger filter area and peripheral margin, the extent of the increase being the shrinkage margin.

In an application involving folding a flap 32 or other similar extension of one or more panels for installation purposes, said flap 32 or like extension dimension will be added to the Panel Length or Panel Width.

A method for utilization of a synthetic filter media of the present invention comprises the following steps.

Step 1: Providing a filter for immersion in a container of cooking oil, said cooking oil at a temperature of up to 204° C. (400° F.), said filter comprising a synthetic felt filter media and a media support.

Step 2: Filtering the cooking oil through said filter. This filtering step comprises re-circulating the cooking oil through said filter until a desired level of filtration is obtained.

Step 3: A cooking oil return step comprising returning the cooking oil to a fryer.

Step 4: A second filtering step after the cooking oil return step (Step 3) comprising filtering a second quantity of hot cooking oil according to Steps 1-4.

Step 5: A filter cleaning step intermediate the cooking oil return step (Step 3) and the second filter step (Step 4). The filter cleaning step comprises one or more of scraping accumulated particulate matter from outer surfaces of said synthetic felt filter media, washing the filter media and removing the filter media from the media support prior to washing the filter and subsequently returning the filter media to the media support.

Step 6: Step 6 comprises at least one repetition of a cooking oil return step like Step 3, a filter cleaning step like Step 5 and a filtering step like Step 4.

It will be appreciated that the method herein described can be practiced in applications where the synthetic filter media comprises a filter envelope or a filter panel. Due to anticipated shrinkage of the synthetic filter media comprised of polyester or nylon at cooking oil temperatures associated with frying operations, the preferred embodiment of the method comprises providing filter media having Panel Length and Panel Width as previously described herein.

The foregoing disclosure and description of the invention is illustrative and explanatory thereof. Various changes in the details of the illustrated-construction may be made within the scope of the appended claims without departing from the spirit of the invention. The present invention should only be limited by the following claims and their legal equivalents.

1. A filter for filtering particulate matter from hot cooking oil, said hot cooking oil having a temperature in a range of up to 204° C. (400° F.), said filter comprising:
at least one filter panel;
at least one filter support;
said at least one filter panel supported on said at least one filter support; and
said at least one filter panel comprising a synthetic felt filter media.

2. The filter of claim 1, said at least one filter panel comprising a polyester felt filter media.

3. The filter of claim 1, said at least one filter panel comprising a nylon felt filter media.

4. The filter of claim 1, wherein:
said at least one filter panel having a determined operational filtering area and operational peripheral margin;
said at least one filter panel initially constructed with an initial filtering area and initial peripheral margin; and
said initial filtering area and initial peripheral margin larger than said operational filtering area and operational peripheral margin.

5. The filter of claim 4, wherein:
said initial filtering area and initial peripheral margin in a range of 2% to 10% larger than said operational filtering area and operational peripheral margin.

6. The filter of claim 5, wherein said at least one filter panel comprising a polyester felt filter media.

7. The filter of claim 5, wherein said at least one filter panel comprising a nylon felt filter media.

8. The filter of claim 6, wherein said nylon felt filter media has at least one glazed surface.

9. The filter of claim 6, wherein said nylon felt filter media has at least one singed surface.

10. A filter envelope for use with a cooking oil filter for filtering particulate matter from hot cooking oil, said hot cooking oil having a temperature in a range of up to 204° C. (400° F.), said filter envelope comprising:
a first filter panel having a first panel perimeter;
a second filter panel having a second panel perimeter;
said first filter panel and said second filter panel attachable along said first panel perimeter and said second panel perimeter to enclose a filter support; and
said first filter panel and said second filter panel comprising a synthetic felt filter media.

11. The filter of claim 10, wherein:
said at least one filter panel having a determined operational filtering area and operational peripheral margin;
said at least one filter panel initially constructed with an initial filtering area and initial peripheral margin; and
said initial filtering area and initial peripheral margin larger than said operational filtering area and operational peripheral margin.

12. The filter of claim 11, wherein:
said initial filtering area and initial peripheral margin in a range of 2% to 10% larger than said operational filtering area and operational peripheral margin.

13. The filter of claim 12, said at least one filter panel comprising a polyester felt filter media.

14. The filter of claim 13, said at least one filter panel comprising a nylon felt filter media.

15. The filter of claim 12, wherein said nylon felt filter media has at least one glazed surface.

16. The filter of claim 12, wherein said nylon felt filter media has at least one singed surface.

17. A method for filtering particulate matter from hot cooking oil, said hot cooking oil having a temperature in a range of up to 204° C. (400° F.), said method comprising:
providing a filter for immersion in said cooking oil, said filter including a synthetic felt filter media and a media support; and
a filter step comprising filtering said cooking oil through said filter.

18. The method of claim 17, wherein said method further comprises:
a cooking oil return step comprising returning said cooking oil to a frying apparatus.

19. The method of claim 18, wherein said method further comprises:
a second filter step after said cooking oil return step comprising filtering a second quantity of hot cooking oil.

20. The method of claim 19, wherein said method further comprises:
a filter scraping step intermediate said cooking oil return step and said second filter step comprising scraping accumulated particulate matter from outer surfaces of said polyester felt filter media.

21. The method of claim 20, wherein said method further comprises:
at least one repetition of said filter scraping step and said second filter step.

22. The method of claim 21, wherein said method further comprises:
a plurality of repetitions of said filter scraping step and said second filter step.

23. The method of claim 17, wherein said synthetic felt filter media comprising a polyester felt filter media.

24. The method of claim 17, wherein said synthetic felt filter media comprising a nylon felt filter media.

25. The method of claim 22, wherein said synthetic felt filter media comprising a polyester felt filter media.

26. The method of claim 22, wherein said synthetic felt filter media comprising a nylon felt filter media.

27. The filter of claim 24, wherein said nylon felt filter media has at least one glazed surface.

28. The filter of claim 24, wherein said nylon felt filter media has at least one singed surface.

29. The filter of claim 25, wherein said nylon felt filter media has at least one glazed surface.

30. The filter of claim 25, wherein said nylon felt filter media has at least one singed surface.
